(19) United States
(12) Patent Application Publication
(10) Pub. No.: US 2009/0011157 A1
(43) Pub. Date: Jan. 8, 2009

(54) Molded Article, A Mold Insert for Producing the Molded Article and a Method of Manufacturing of the Mold Insert

(75) Inventors: Laurent Christel Sigler, Hettange-Grande (FR); Jean-Christophe Witz, Yutz (FR)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/773,468

(22) Filed: Jul. 5, 2007

(51) Int. Cl. B29D 22/00

(52) U.S. Cl. 428/34.1; 264/219; 425/556

(57) ABSTRACT

There is provided a preform, a molded article, a mold insert for producing the molded article and a method of manufacture of the mold insert. A mold assembly comprises a core insert defining a first molding contact surface; said first molding contact surface comprising a first impacting pattern; a cavity insert defining a second molding contact surface; said second molding contact surface comprising a second impacting pattern; said first impacting pattern being rougher than said second impacting pattern.

### FIELD OF THE INVENTION

The present invention generally relates to, but is not limited to, molding systems, and more specifically the present invention relates to, but is not limited to, a molded article, a mold insert for producing the molded article and a method of manufacturing the mold insert.

### BACKGROUND OF THE INVENTION

Molding is a process by virtue of which a molded article can be formed from molding material by using a molding system. Various molded articles can be formed by using the molding process, such as an injection molding process. One example of a molded article that can be formed, for example, from polyethylene terephthalate (PET) is a beverage container, such as, a bottle for a soft drink, a carbonated drink, fruit juices and the like. Generally speaking, molding systems for producing beverage containers and articles in general can be categorized into two generic categories—(a) a one stage blow-molding system and (b) a two stage blow-molding system.

When the two stage blow-molding system is utilized, a preform capable of subsequently being blow-molded into a final-shaped molded article is first produced. The preform can be produced using a molding system, such as for example, an injection molding system. A typical molding system includes an injection unit, a molding machine and a mold assembly. The injection unit can be of a reciprocating screw type or of a two-stage type. The molding machine includes inter alia a frame, a movable platen, a fixed platen and an actuator for moving the movable platen and to apply tonnage to the mold assembly arranged between the platens. The mold assembly includes inter alia a cold half and a hot half. The hot half is usually associated with one or more cavities (and, hence, also sometimes referred to by those of skill in the art as a “cavity half”), while the cold half is usually associated with one or more cores (and, hence, also sometimes referred to by those of skill in the art as a “core half”). The one or more cavities together with one or more cores define, in use, one or more molding cavities. The hot half can also be associated with a melt distribution system (also referred to sometimes by those of skill in the art as a “hot runner”) for melt distribution. The mold assembly can be associated with a number of additional components, such as neck rings, neck ring slides, ejector structures, wear pads, etc.

As an illustration, injection molding of PET material involves heating the PET material (ex. PET pellets, PEN powder, PLA, etc.) to a homogeneous molten state and injecting, under pressure, the so-melted PET material into the one or more molding cavities defined, at least in part, by the aforementioned one or more cavities and one or more cores mounted respectively on a cavity plate and a core plate of the mold assembly. The cavity plate and the core plate are urged together and are held together by clamp force, the clamp force being sufficient enough to keep the cavity and the core together against the pressure of the injected PET material. The molding cavity has a shape that substantially corresponds to a final cold-state shape of the molded article to be molded. The so-injected PET material is then cooled to a temperature sufficient to enable ejection of the so-formed molded article from the mold. When cooled, the molded article shrinks inside of the molding cavity and, as such, when the cavity and core plates are urged apart, the molded article tends to remain associated with the core. Accordingly, by urging the core plate away from the cavity plate, the molded article can be demolded, i.e. ejected off of the core piece. Ejection structures are known to assist in removing the molded articles from the core halves. Examples of the ejection structures include stripper plates, ejector pins, etc.

Once the molded articles (ex. one or more preforms) are cooled down to a transportable state, they can be transferred to another part of the same facility or to a different facility. At a subsequent instance in time, the preform is blow-molded into a final-shaped molded article. The process is carried out in blow-molding equipment. Within a typical blow-molding system, a preform is first heated to a required state in a heating portion and is then formed into the final-shaped molded article in a stretch-blow molding portion. Typically, the heating portion comprises one or more infrared emitters for emitting infrared energy. Typically, also provided in the heating portion are one or more blowers to provide air movement. The air movement is meant to serve two purposes. Firstly, it removes some heat from the outside surface of the preforms (also referred to as a “skin”) to avoid burning. Secondly, the air movement is used to at least partially ventilate the infrared emitters and to at least partially cool the infrared emitters to prevent them from premature damage due to high temperature. Typically, the forming is achieved by (i) positioning the so-reheated preform in a blow-molding cavity; (b) blowing air on an internal surface of the so-reheated preform; and (c) optionally, stretching axially the preform, for example, by using a stretch rod and the like.

When the single stage blow-molding system is utilized, the process of producing a parison and subsequent blowing operation is carried out substantially one after another. An example of the single-stage blow-molding system is disclosed in U.S. Pat. No. 6,730,260 issued to Vardin et al. on May 4, 2004. However, many other examples will be known to those of skill in the art.

U.S. Pat. No. 5,312,572 issued to Horwege on May 17, 1994 discloses a preform of a thermoplastic material, especially a material which is orientable during blow forming, which has an opening region, a closed bottom as well as walls connecting the bottom with the opening region. In the region of at least a part of the surface demarcating the preform a texturing enlarging the surface is provided, which has a low profile depth relative to the wall thickness of the preform. A process for heating a preform of a thermoplastic material is also disclosed which includes texturing a portion of the surface of the preform to enlarge the surface area thereof whereby the time required to heat the preform to a desired temperature suitable for blow molding is reduced. The preform is also rotated as it is moved past a heating device and the heating device is controlled such that the heating device combination with the texturing provides a desired temperature profile rendering the preform suitable for blow molding.

### SUMMARY OF THE INVENTION

According to a first broad aspect of the present invention, there is provided a mold assembly. The mold assembly comprises a core insert defining a first molding contact surface; the first molding contact surface comprising a first impacting pattern; a cavity insert defining a second molding contact surface; the second molding contact surface comprising a second impacting pattern; the first impacting pattern being rougher than the second impacting pattern.

According to a second broad aspect of the present invention, there is provided a molded article. The molded article comprises an inner skin defining a first impacted pattern; an outer skin defining a second impacted pattern; the first impacted pattern being rougher than the second impacted pattern.

According to a third broad aspect of the present invention, there is provided a method of manufacturing of a mold insert. The method comprises forming a first impacting pattern on a first mold insert, the first mold insert being one of a core insert, a cavity insert and a gate insert; and a second impacting pattern on a second mold insert, the second mold insert being at least one of the others of the core insert, the cavity insert and the gate insert, wherein a shape of the first impacting pattern and a shape of the second impacting pattern are selected such that if the first mold insert, in use, shapes an inner skin of a molded article and the second mold insert, in use, shapes an outer skin of the molded article, then the shape of the first impacting pattern is rougher than the shape of the second impacting pattern.

According to a fourth broad aspect of the present invention, there is provided a method of manufacturing of a mold insert. The method comprises forming an impacting pattern on at least one of a core insert, a cavity insert and a gate insert using a knurling tool.

According to a fifth broad aspect of the present invention, there is provided a method of molding a molded article. The method comprises injecting a melt into a molding cavity defined between: a core insert defining a first molding contact surface; the first molding contact surface comprising a first impacting pattern; a cavity insert defining a second molding contact surface; the second molding contact surface comprising a second impacting pattern; the first impacting pattern being rougher than the second impacting pattern.

According to another broad aspect of the present invention, there is provided a first mold insert, the first mold insert being complementary to a second mold insert such that the first mold insert and the second mold insert, in use, define a molding cavity, at least in part; the first mold insert comprising: a molding contact surface for forming one of an inner skin and an outer skin of a molded article; the molding contact surface defining a first impacting pattern selected relative to a second impacting pattern defined on the second mold insert such that if the first mold insert, in use, shapes the inner skin of the molded article and the second mold insert, in use, shapes the outer skin of the molded article, then the shape of the first impacting pattern is rougher than the shape of the second impacting pattern.

According to another broad aspect of the present invention, there is provided a molded article. The molded article comprises an inner skin defining a first impacted pattern having a first roughness; an outer skin defining a second impacted pattern having a second roughness; the first roughness and the second roughness being selected such that to decrease temperature differential between the inner skin and the outer skin during reheating in a blow-molding operation.

### DESCRIPTION OF THE DRAWINGS

A better understanding of the embodiments of the present invention (including alternatives and/or variations thereof) may be obtained with reference to the detailed description of the exemplary embodiments along with the following drawings, in which:

FIG. 1 is a cross section view of a portion of a molding system 100.

FIG. 2 is a cross section view of a core base 114 of a core insert 102 of the molding system 100 of FIG. 1, according to a non-limiting embodiment of the present invention.

FIG. 3 is a cross section view of a cavity insert 104 of the molding system 100 of FIG. 1, according to a non-limiting embodiment of the present invention.

FIG. 4 is a cross section view of a preform 410 that can be produced using the molding system 100 of FIG. 1, according to a non-limiting embodiment of the present invention.

The drawings are not necessarily to scale and are may be illustrated by phantom lines, diagrammatic representations and fragmentary views. In certain instances, details that are not necessary for an understanding of the exemplary embodiments or that render other details difficult to perceive may have been omitted.

### DETAILED DESCRIPTION OF EMBODIMENTS

Inventors have appreciated that molding material, such as PET for example, has a standard rate of heat absorbance, which is linked to the chemical composition thereof. Heat absorbance plays a role in the blow-molding processes and, more specifically, during the aforementioned heating stage in the blow-molding system. The higher the heat absorbance, the faster a preform can be heated to a state where it can be formed into the final-shaped molded article. Inventors have also appreciated that it may be desirable to keep a temperature differential between an outer skin and an inner skin of the preform as low as possible.

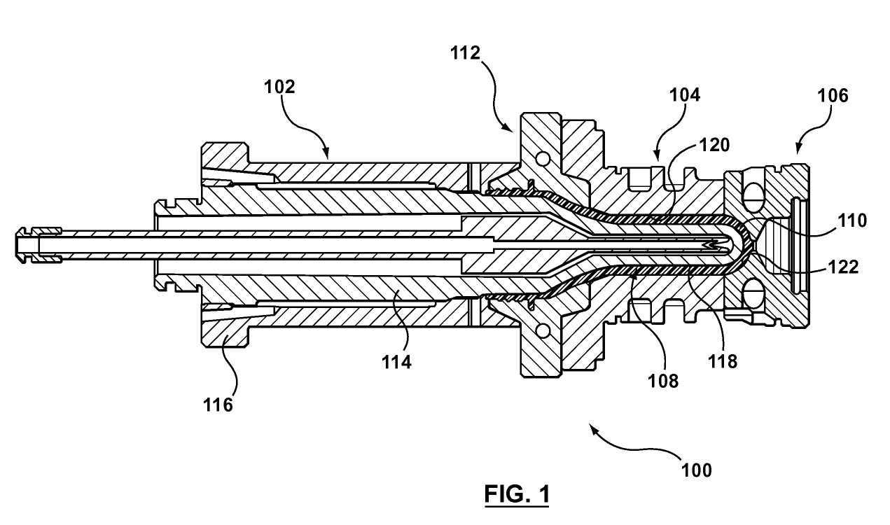

With reference to FIG. 1 there is depicted a cross section of a portion of a molding system 100 that can be used to implement embodiments of the present invention. More specifically, the molding system 100 comprises a core insert 102, a cavity insert 104 and a gate insert 106. The core insert 102, the cavity insert 104 and the gate insert 106 cooperate, in use, to define together a molding cavity 108. Shape of the molding cavity 108 corresponds to a shape of a molded article 110, which in some embodiments of the present invention can comprise a preform capable of being subsequently blow-molded into a container and the like.

Also depicted in FIG. 1 are a number of additional components, such as neck rings 112, cooling channels (not separately numbered), etc. All of these additional components are known to those of skill in the art and, as such, will not be described here at any length.

The core insert 102 comprises a core base 114 and a retaining member 116. The retaining member 116 is configured to lock, in an operational configuration, the core base 114 to a core plate (not depicted) of the molding system 100. The core base 114 comprises a first molding contact surface 118. The first molding contact surface 118 is a portion of the core base 114 that defines, in use, a portion of the molded article 110. In other words, the first molding contact surface 118 is a portion of the core base 114 that shapes, in use, a portion of the molded article 110.

The cavity insert 104 comprises a second molding contact surface 120. The second molding contact surface 120 is a portion of the cavity insert 104 that defines, in use, a portion of the molded article 110. In other words, the second molding contact surface 120 is a portion of the cavity insert 104 that shapes, in use, a portion of the molded article 110.

The gate insert 106 comprises a third molding contact surface 122 The third molding contact surface 122 is a portion of the gate insert 106 that defines, in use, a portion of the molded article 110. In other words, the third molding contact surface 122 is a portion of the gate insert 106 that shapes, in use, a portion of the molded article 110.

As will be appreciated, a portion of the molded article 110 can be shaped by a molding contact surface defined on one or more other mold inserts, such as, for example, the aforementioned neck rings (not separately numbered).

It should be noted that FIG. 1 depicts just one non-limiting example of the molding system 100 that can be used to implement embodiments of the present invention. It should be noted that in alternative non-limiting embodiments of the present invention, the molding system 100 may have other configurations. For example, the gate insert 106 may be omitted and the cavity insert 104 and the core insert 102 may define a substantially whole portion of a body of the molded article 110. In other non-limiting embodiments of the present invention, the core insert 102 and/or the cavity insert 104 and/or the gate insert 106 do not need to be inserts per se. In other words, the core insert 102 and/or the cavity insert 104 and/or the gate insert 106 can be implemented as integral members of a core plate (not depicted) and a cavity plate (not depicted). Other alternative implementation, are of course, also possible.

In some embodiments of the present invention, at least one of the first molding contact surface 118, the second molding contact surface 120 and the third molding contact surface 122 comprises an impacting pattern. Generally speaking, the purpose of the impacting pattern is to impact, in use, onto at least a portion of the molded article 110 an impacted pattern. In some embodiments of the present invention, the impacted pattern located in a given region of the molded article 110 is configured to increase the heat absorbance of the given region of the molded article 110. In other embodiments of the present invention, the impacted pattern may also serve an additional function, such as to improve ease of releasing of the molded article 110 during de-molding. As will be discussed in further detail herein below, in some embodiments of the present invention, some of the impacted patterns may serve to improve ease of releasing of the molded article 110 during the de-molding, while others of the impacted patterns may serve both the function of improving heat absorbance and the function of improving ease of releasing of the molded article 110 during de-molding.

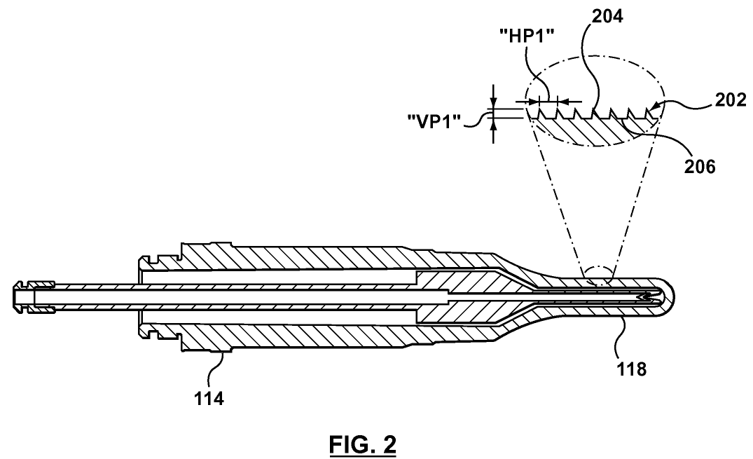

With reference to FIG. 2, a cross section of the core base 114 of FIG. 1, according to a non-limiting embodiment of the present invention, is depicted. The first molding contact surface 118 of the core base 114 comprises an impacting pattern 202. The impacting pattern 202 comprises a plurality of peaks 204 and a plurality of valleys 206. A distance between any two given peaks 204, generally depicted at “HP1”, will be referred to herein below as a “horizontal pitch” of the impacting pattern 202. The horizontal pitch “HP1” can be constant between any two and/or all of given peaks 204 or it can be different. The impacting pattern 202 can be also said to be associated with a vertical pitch, depicted in FIG. 2 at “VP1”. The vertical pitch “VP1” is a height associated with the plurality of peaks 204. The vertical pitch “VP1” can be substantially constant between any two and/or all of given peaks 204 or it can be different.

In some embodiments of the present invention, the impacting pattern 202 can encompass substantially the entire length of first molding contact surface 118 of the core base 114. In alternative non-limiting embodiments of the present invention, the impacting pattern 202 can encompass a portion of first molding contact surface 118 of the core base 114.

In some embodiments of the present invention, the impacting pattern 202 can be produced using known sand blasting or equivalent tools. In other embodiments of the present invention, the impacting pattern 202 can be produced by using a knurling tool. A non-limiting example of a suitable knurling tool that can be adapted to implement non-limiting embodiments of the present invention is knurling wheel DIN 403 available from Zeus Tooling of Germany (http://www.zeus-tooling.de/). However, it should be understood that other suitable tools can also be used. In yet further non-limiting embodiments of the present invention, the impacting pattern 202 can be produced using known laser-treatment tools. In yet further non-limiting embodiments of the present invention, the impacting pattern 202 can be produced using known erosion techniques, such as by chemical processes or by electrical discharge machining tools. Alternatively, electro-chemical tools can be used. Other alternatives for producing the impacting pattern 202 are, of course, also possible.

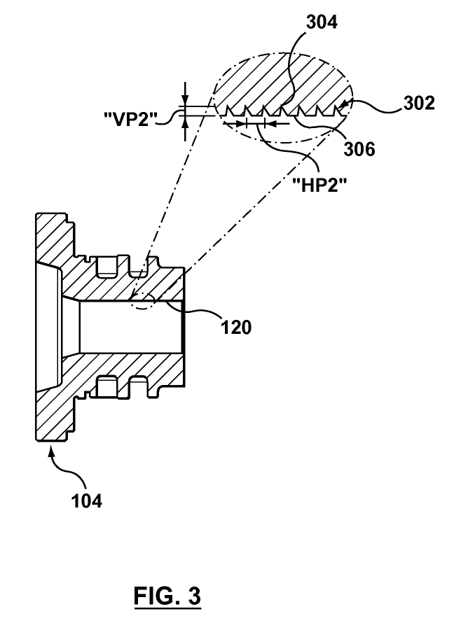

With reference to FIG. 3, a cross section of the cavity insert 104 of FIG. 1, according to a non-limiting embodiment of the present invention, is depicted. The second molding contact surface 120 comprises an impacting pattern 302. The impacting pattern 302 comprises a plurality of peaks 304 and a plurality of valleys 306. A distance between any two given peaks 304, generally depicted at “HP2”, will be referred herein below as a “horizontal pitch” of the impacting pattern 302. The horizontal pitch “HP2” can be constant between any two and/or all of given peaks 304 or it can be different. The impacting pattern 302 can be also said to be associated with a vertical pitch, depicted in FIG. 3 at “VP2”. The vertical pitch “VP2” is a height associated with the plurality of peaks 304. The vertical pitch “VP2” can be substantially constant between any two and/or all of the plurality of peaks 304 or it can be different.

In some embodiments of the present invention, the impacting pattern 302 can encompass substantially the entire length of the second molding contact surface 120 of the cavity insert 104. In alternative non-limiting embodiments of the present invention, the impacting pattern 302 can encompass a portion of the second molding contact surface 120 of the cavity insert 104.

In some embodiments of the present invention, the impacting pattern 302 can be produced using known sand blasting or other equivalent tools. In other embodiments of the present invention, the impacting pattern 302 can be produced by using a knurling tool, similar to the knurling tool that can be used for the impacting pattern 202. In yet further non-limiting embodiments of the present invention, the impacting pattern 302 can be produced using known laser-treatment tools. In yet further non-limiting embodiments of the present invention, the impacting pattern 302 can be produced using known erosion techniques, such as by chemical processes or by electrical discharge machining tools. Alternatively, electro-chemical tools can be used. Other alternatives for producing the impacting pattern 302 are, of course, also possible.

In some embodiments, the third molding contact surface 122 can also comprise an impacting pattern, similar to the impacting pattern 302. Within these embodiments of the present invention, the impacting pattern defined on the third molding contact surface 122 can have a horizontal pitch similar to the horizontal pitch “HP2” and a vertical pitch similar to the vertical pitch “VP2” of the impacting pattern 302. However, in alternative non-limiting embodiments of the present invention, the third molding contact surface 122 does not need to comprise an impact surface.

Generally speaking, shape of the impacting pattern 202 and the impacting pattern 302 are chosen such that the impacting pattern 202 is rougher than the impacting pattern 302. How the roughness of the impacting pattern 202 and the impacting pattern 302 are chosen will be discussed in greater detail herein below. It is worthwhile noting that inventors believe that selection of the horizontal pitch (such as the horizontal pitch “HP1” and the horizontal pitch “HP2”) has an impact on heat absorbance of a selected region of the molded article 110 where an impacted pattern is produced by the impacting pattern of a given horizontal pitch, while selection of the vertical pitch (such as the vertical pitch “VP1” and the vertical pitch “VP2”) has an impact on how visual the impacted pattern is on the final-shaped article (i.e. after it has been blow-molded).

It should be noted that the exact dimensions of the horizontal pitch “HP1” and the horizontal pitch “HP2” are not particularly limited. The dimension for the horizontal pitch “HP1” and the horizontal pitch “HP2” are selected so that the horizontal pitch “HP1” is larger than horizontal pitch “HP2”. In some embodiments of the present invention, the horizontal pitch “HP2” can be selected such that to produce an impacted pattern that will improve ease of releasing during de-molding, but not necessarily increase heat absorbance of a portion of the molded article 110. In other embodiments of the present invention, the second molding contact surface 120 can be produced by using known polishing techniques and, as such, can be comparatively smooth. For example, the second molding contact surface 120 of the cavity insert 104 can be obtained by polishing and, as such, the horizontal pitch “HP2” can be substantially close to zero.

In yet further embodiments of the present invention, the horizontal pitch “HP2” can be selected such that to produce an impacted pattern that will improve ease of releasing during de-molding and increase heat absorbance of a portion of the molded article 110, albeit not to the same degree as the impacted pattern produced by horizontal pitch “HP1”.

In some embodiments of the present invention, the horizontal pitch “HP1” can be selected to substantially equal at least the half-wavelength of the infrared emitters used for preheating in the blow-molding stage. In other embodiments of the present invention and as a non-limiting example of a range that can be used for selecting the pitch horizontal “HP1” and the horizontal pitch “HP2” includes 0.6 μm-600 μm. The selection of the particular dimension is made keeping in mind that the rougher the surface (as for example, represented by the horizontal pitch “HP1”, “HP2” or the vertical pitch “VP1”, “VP2”), the higher the rate of heat absorbance is. Accordingly, it can be said that the selection is made so that the impacting pattern 202 of the core base 114 produces an impacted pattern having heat absorbance that is higher than that of an impacted pattern produced by the impacting pattern 302 of the cavity insert 104.

As is known to those skilled in the art, RA value represents a mean of heights of the peaks (such as peaks 204, 304) over a given length covered by the peaks (such as peaks 204, 304). In some embodiments of the present invention, the roughness of the impacting pattern 202 and the roughness of the impacting pattern 302 are selected such that the RA value associated with the impacting pattern 202 is greater than that of the impacting pattern 302. In a specific non-limiting embodiment, the impacting pattern 202 has been selected so that RA value of the impacting pattern 202 is 3 μm and the impacting pattern 302 has been selected so that the RA value of the impacting pattern 302 is 1 μm. It should be expressly understood that this is just one example and other possible RA values are within scope of embodiments of the present invention. It should be noted that the RA value is just one but many examples of the value that can be used for selecting the roughness of the impacting pattern 202 and the impacting pattern 302. Other examples include, but are not limited to, RY value (difference between a minimum height and a maximum height), RZ value (a mean of heights over any given five horizontal pitches) and the like.

In alternative non-limiting embodiments of the present invention, which are particularly applicable when no concerns regarding visibility of the impacted pattern on the final-shaped article exist, the roughness of the impacting pattern 202 and the impacting pattern 302 can be selected with no regard to the respective RA values.

In those embodiments of the present invention, where the third molding contact surface 122 also defines an impacting pattern, the impacting pattern 202 of the core base 114 is selected such that it is also rougher than the impacting pattern of the gate insert 106.

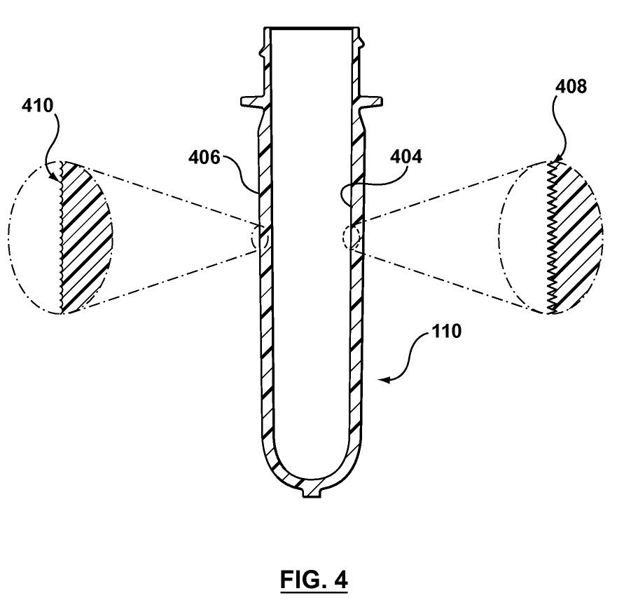

With reference to FIG. 4, a cross section of the molded article 110 of FIG. 1, according to a non-limiting embodiment of the present invention, is depicted. In the specific non-limiting embodiment depicted in FIG. 4, the molded article 110 comprises a preform capable of being subsequently blow-molded into a beverage container. However, this need not be so in every embodiments of the present invention. The molded article 110 can be of any type and/or shape suitable for subsequent blow-molding into a final-shaped product.

The molded article 110 comprises an inner skin 404 and an outer skin 406. The inner skin 404 has been produced, at least in part, by contact between the melt and the aforementioned first molding contact surface 118 of the core base 114. The outer skin 406 has been produced, at least in part, by contact between the melt and the aforementioned second molding contact surface 120 of the cavity insert 104 and the third molding contact surface 122 of the gate insert 106.

The inner skin 404 comprises an impacted pattern 408, the shape of the impacted pattern 408 corresponding to the shape of the impacting pattern 202. The outer skin 406 comprises an impacted pattern 410, the shape of the impacted pattern 410 corresponding (at least in part) to the shape of the impacting pattern 302. Recalling that the shapes of the impacting pattern 202 and the impacting pattern 302 are selected such that the impacting pattern 202 is rougher than the impacting pattern 302, the impacted pattern 408 has a rougher texturing or, simply put, is rougher than the impacted pattern 410.

It should be noted that the description provided herein above describes just a few non-limiting embodiments of the present invention. Numerous alternative embodiments are possible. For example, the shape of the impacting pattern 202 and the impacting pattern 302 can be varied to a number of alternative implementations. For example, the impacting pattern 202 and/or the impacting pattern 302 can be implemented as circular or conical protrusions, etc. Furthermore, the shape of the impacting pattern 202 and/or the impacting pattern 302 does not have to constant over a respective length thereof.

When the molded article 110 is subsequently blow-molded into a final-shaped article and, more particularly, when the molded article 110 is subjected to infrared energy during the heating stage, more energy is absorbed by the inner skin 404 than by the outer skin 406 due, at least partially, to the impacted pattern 408 being rougher than the impacted pattern 410. Since some of the temperature of the outer skin 406 is lost due to presence of convection within the heating portion of the blow-molding system and since the temperature if the inner skin 404 is larger than of the convention preforms due to the rougher surface thereof, a technical effect of some of the embodiments of the present invention is a comparatively lower temperature differential between the inner skin 404 and the outer skin 406. Another technical effect of some of the embodiments of the present invention may include the reduced time cycle as preforms produced according to embodiments of the present invention can be produced faster than conventional preforms. Another technical effect of the aspects of the present invention may include energy savings during blowing reheat phase attributable, at least in part, to a high heat absorbance of preforms produced according to embodiments of the present invention. It should be expressly understood that not all of the technical effects, in their entirety, need be realized in each and every embodiments of the present invention.

Even though the foregoing description has described the core insert 102 defining a first molding contact surface 118 with the impacting pattern 202 and the cavity insert 104 defining the second molding contact surface 120 with the impacting pattern 302, the impacting pattern 202 being rougher than the impacting surface 302, it should be understood that the knurling tool described above can be used for producing the impacting pattern 202 and the impacting surface 302 of substantially similar roughness or even with the impacting surface 302 being rougher than the impacting pattern 202. Some of the technical effects associated with the use of knurling tool include simplified or removed manual steps, automation of the process (i.e. possibility to mount the knurling tool onto a turning center used for machining, for example, the core insert).

Description of the embodiments of the present inventions provides examples of the present invention, and these examples do not limit the scope of the present invention. It is to be expressly understood that the scope of the present invention is limited by the claims only. The concepts described above may be adapted for specific conditions and/or functions, and may be further extended to a variety of other applications that are within the scope of the present invention. Having thus described the embodiments of the present invention, it will be apparent that modifications and enhancements are possible without departing from the concepts as described. Therefore, what is to be protected by way of letters patent are limited only by the scope of the following claims:

1. A mold assembly comprising:
a core insert defining a first molding contact surface; said first molding contact surface comprising a first impacting pattern;
a cavity insert defining a second molding contact surface; said second molding contact surface comprising a second impacting pattern;
said first impacting pattern being rougher than said second impacting pattern.

2. The mold assembly of claim 1, wherein said first impacting pattern is associated with a first horizontal pitch and said second impacting pattern is associated with a second horizontal pitch, and wherein said first horizontal pitch is greater than said second horizontal pitch.

3. The mold assembly of claim 1, wherein said first impacting pattern is associated with a first vertical pitch and said second impacting pattern is associated with a second vertical pitch, and wherein said first vertical pitch is greater than said second vertical pitch.

4. The mold assembly of claim 3, wherein said first vertical pitch and said second vertical pitch are selected based on a respective value, the respective value being one of an RA value, an RY value and an RZ value.

5. The mold assembly of claim 1, wherein:
said first impacting pattern is associated with a first horizontal pitch and said second impacting pattern is associated with a second horizontal pitch, and wherein said first horizontal pitch is greater than said second horizontal pitch; and wherein
said first impacting pattern is associated with a first vertical pitch and said second impacting pattern is associated with a second vertical pitch, and wherein said first vertical pitch is greater than said second vertical pitch.

6. The mold assembly of claim 1, wherein said first impacting pattern covers substantially the whole length of said first molding contact surface.

7. The mold assembly of claim 1, wherein said first impacting pattern covers a portion of said first molding contact surface.

8. The mold assembly of claim 1, wherein said second impacting pattern covers substantially the whole length of said second molding contact surface.

9. The mold assembly of claim 1, wherein said second impacting pattern covers a portion of said second molding contact surface.

10. A molded article comprising:
an inner skin defining a first impacted pattern;
an outer skin defining a second impacted pattern;
said first impacted pattern being rougher than said second impacted pattern.

11. The molded article of claim 10, wherein a shape of said second impacted pattern is selected such that to improve ease of releasing during demolding.

12. The molded article of claim 10, wherein a shape of said second impacted pattern is selected such that to improve ease of releasing during demolding and to increase heat absorbance.

13. The molded article of claim 10, wherein said first impacted pattern covers at least a portion of said outer skin.

14. The molded article of claim 10, wherein said second impacted pattern covers at least a portion of said inner skin.

15. A method of manufacturing of a mold insert, the method comprising:
forming (i) a first impacting pattern on a first mold insert, the first mold insert being one of a core insert, a cavity insert and a gate insert; and (ii) a second impacting pattern on a second mold insert, the second mold insert being at least one of the others of the core insert, the cavity insert and the gate insert,
wherein a shape of the first impacting pattern and a shape of the second impacting pattern are selected such that if the first mold insert, in use, shapes an inner skin of a molded article and the second mold insert, in use, shapes an outer skin of the molded article, then the shape of the first impacting pattern is rougher than the shape of the second impacting pattern.

16. The method of claim 15, wherein said forming comprises using a sand blasting tool.

17. The method of claim 15, wherein said forming comprises using a knurling tool.

18. The method of claim 15, wherein said forming comprises using a laser-treatment tool.

19. The method of claim 15, wherein said forming comprising using an erosion technique.

20. The method of claim 15, wherein said forming comprises using an electro-chemical tool.

21. A method of manufacturing of a mold insert, the method comprising:
forming an impacting pattern on at least one of a core insert, a cavity insert and a gate insert using a knurling tool.

22. The method of claim 21, wherein said forming comprises:
forming a first impacting pattern on said core insert;
forming a second impacting pattern on said cavity insert.

23. The method of claim 22, wherein said first impacting pattern is rougher than said second impacting pattern.

24. The method of claim 22, wherein said first impacting pattern is substantially equal to said second impacting pattern.

25. The method of claim 22, wherein said second impacting pattern is rougher than said first impacting pattern.

26. The method of claim 22, further comprising forming said second impacting pattern on said gate insert.

27. A method of molding a molded article, comprising:
injecting a melt into a molding cavity defined between:
a core insert defining a first molding contact surface; said first molding contact surface comprising a first impacting pattern;
a cavity insert defining a second molding contact surface; said second molding contact surface comprising a second impacting pattern;
said first impacting pattern being rougher than said second impacting pattern.

28. A first mold insert, the first mold insert being complementary to a second mold insert such that the first mold insert and the second mold insert, in use, define a molding cavity, at least in part; the first mold insert comprising:
a molding contact surface for forming one of an inner skin and an outer skin of a molded article; the molding contact surface defining
a first impacting pattern selected relative to a second impacting pattern defined on the second mold insert such that if the first mold insert, in use, shapes the inner skin of the molded article and the second mold insert, in use, shapes the outer skin of the molded article, then the shape of the first impacting pattern is rougher than the shape of the second impacting pattern.

29. A molded article comprising:
an inner skin defining a first impacted pattern having a first roughness;
an outer skin defining a second impacted pattern having a second roughness;
said first roughness and said second roughness being selected such that to decrease temperature deferential between said inner skin and said outer skin during reheating in a blow-molding operation.
